(19) United States
(12) Patent Application Publication
(10) Pub. No.: US 2006/0111962 A1
(43) Pub. Date: May 25, 2006

(54) Survey system and method

(76) Inventor: Taylor Holsinger, Duvall, WA (US)

Correspondence Address: Brett N. Dorny, Esq.;LAW OFFICE OF BRETT N. DORNY, 321 Church Street, Northborough, MA, 01532, US

(21) Appl. No.: 10/995,069

(22) Filed: Nov. 22, 2004

(51) Int. Cl. G06F 17/30

(52) U.S. Cl. 705/10

(57) ABSTRACT

A survey system and method are disclosed for conducting targeted surveys of purchase decisions. Participants are registered and demographic information is stored in a database. Each participant has an RFID tag which is used to locate the participant at particular locations in a store. When a participant is detected at a particular location and meets the demographic criteria, a survey is conducted over a mobile telephone with respect to a purchase decision.

### BACKGROUND OF THE INVENTION

1. Field of the Invention

The present invention relates to a telephone survey system. More particularly, it relates to a system for conducting a telephone survey based upon a determined location of a subject.

2. Discussion of Related Art

Consumer research is a growing industry. The most common process for conducting research is a survey, in which participants are asked a series of questions relating to purchase decisions or activities. Such techniques can be problematic for obtaining accurate information. The survey process can be time consuming in order to collect the demographic information necessary to provide meaningful results from the survey analysis. Thus, busy shoppers are often unwilling to participate in such surveys.

The survey may also be conducted at a time other than when a purchase has been recently made. Surveys may ask participants about buying habits and purchase decisions, either past or future. However, the answers are often biased by the previously made decision or voided by a variation in future behavior. Furthermore, when a survey is conducted after a purchase has been made, participants have a need to justify their decision, which can alter a true understanding of the decision process. Survey techniques which monitor decisions as they are made can provide the best source of reliable data.

Technology has provided the capability for improved survey techniques. For example, nearly 10 years ago, New York-based Jupiter Media Metrix Inc. realized that software could track a consumer's Internet behavior continuously and effortlessly. Participants agree to be part of the process. They provide the necessary demographic information at a time convenient to them. The information is stored and later used with data to analyze the activities of the participants. Every day more than 50 million Internet users worldwide are being tracked—with permission—for commercial purposes. Nielsen NetRatings, a Media Metrix competitor, will sell nearly $50 million worth of that anonymous data in 2004.

Another example is the Portable People Meter (PPM) being tested by a joint venture between New York-based companies Arbitron and Nielsen Media Research Inc. The PPM is a pager-like device that clips to the belts of panelists. The device “listens” to its environment and takes note of special signals inserted into the audio channels of radio and television broadcasts. The PPM records the time and duration a particular signal is heard, and when it is returned to its charger base each night, it transmits that data to the Arbitron system. The data is then used to determine the precise activities of participants.

Similarly, Forrester Research recently unveiled its Ultimate Consumer Panel, a panel of 10,000 consumers nationwide that tracks many passive consumer data streams. Ultimate receives permission from its panelists to electronically and anonymously track monthly credit card statements, checking account statements, and wireless and residential phone bills in addition to monitoring its panelists' online behavior. Add to this the ability to survey its members and Forrester's Ultimate Consumer Panel can determine things that were previously impossible to track reliably.

These technological solutions monitor participants behavior and seek to determine motives from behavior. While they are less intrusive for the participants, they lack much of the value obtained from survey techniques which request the opinions of participants.

### SUMMARY OF THE INVENTION

According to one aspect, the present invention includes a method for conducting targeted surveys. The method includes determining the location of a consumer who is likely making an purchase decision and conducting a survey related to that purchase decision. The location may be determined using an RFID tag carried by the consumer and an RFID reader. The determining may be further made based upon a time period in which the consumer remains at the location.

Additionally, the survey method includes collection of information, including demographic information relating to consumers. The survey to be conducted is selected based upon the location of the consumer and the demographic information relating to the consumer. The survey may be conducted over a mobile phone of the consumer.

According to another aspect of the invention, a method for conducting a consumer survey includes collecting information about a plurality of participants, providing identification devices to the participants, determining the presence of a participant at a predetermined location, and conducting a survey of a participant. The identification devices may be RFID tags. The survey may be selected based upon the predetermined location and demographic information about the participant.

According to another aspect, the present invention provides a system for conducting targeted surveys of willing participants who are currently making a purchase decision of interest. The system locates users who are likely making a purchase decision of interest. According to one aspect of the invention, an RFID tag is carried by participants. The participants have previously provided background and demographic information which is stored in a database. The database is connected to a computer of an RFID reader network. The RFID reader network determines the location of a participant who is likely making a purchase decision. According to one aspect of the invention, the determination is made based upon the presence of the participant in a location of a store representing a likely purchase decision. The participant is provided with a survey regarding the likely purchase decision. According to one aspect of the invention, the survey is conducted over a mobile telephone.

According to another aspect of the invention, once a participant is determined to be in a location where a purchase decision is likely, the demographics of the participant are reviewed. The participant is selected for a survey only if the demographics of that participant meet the criteria for a particular survey.

### BRIEF DESCRIPTION OF THE DRAWINGS

FIG. 1 illustrates a survey system according to an embodiment of the present invention.

FIG. 2 illustrates the use of RFID readers in a survey system according to an embodiment of the present invention.

FIG. 3 is a flow diagram of processing according to an embodiment of the present invention.

### DETAILED DESCRIPTION

The present invention provides a system for conducting consumer surveys at the time purchase decisions are being made. It combines RFID technology for locating a subject and mobile telephone technology for conducting the survey. In order to implement the survey system of the present invention, a large number of willing potential survey participants must be located. The participants must agree to be part of the survey process. Also, a sufficient number of participants is needed so that proper analysis can be made of the survey data. Conventional means are used to locate and register willing participants. Various incentives can be used to attract participants, such as payments for completed surveys, free or discounted products, etc.

Demographic information is collected about each of the participants. Personal information may or may not be collected. If payments are going to be made, personal information, such as a name and an address will need to be collected. Additional personal information may also be necessary in order to verify the validity of the survey information and techniques. The demographic and personal information are stored in a survey database 40. The survey database 40 is in the memory of a programmed computer (not shown). The computer is programmed, as is known in the art, to perform the functions of the survey system. Any type of computer could be used which has sufficient memory, processing power, and communication capability to perform the necessary functions of the present invention. Additionally, the survey database may be stored in one or more memories in one or more computers. Separate databases may be used for demographic and personal information.

Each participant is provided with a RFID tag. According to an embodiment of the invention, the RFID tag is attached to or placed within a mobile or cellular telephone 20 belonging to the participant. Alternatively, the RFID tag can be included on a card carried in the user's wallet or on a key ring. The RFID tag should be configured so that it is easily and regularly carried by the participant. Any type of RFID tag can be used. Preferably, the RFID tag is of the passive type, but it could be an active type. Each RFID tag is associated with a specific participant in the survey database 40.

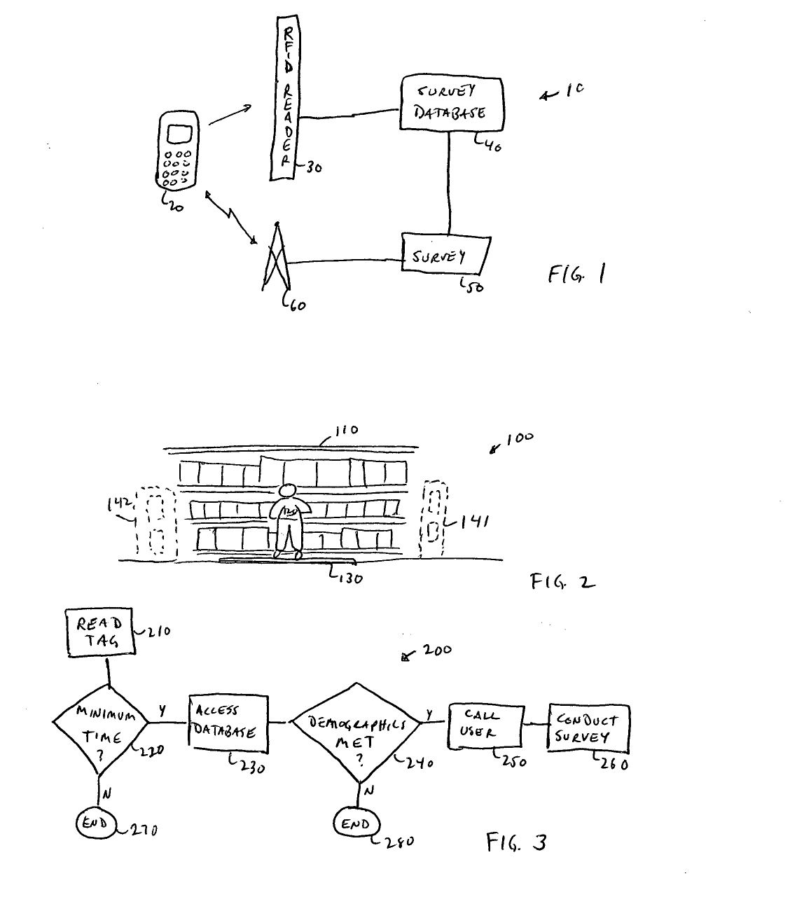

The system 10 further includes a plurality of RFID readers, one of which is shown in FIG. 1. As is known in the art, the RFID reader is connected to the computer containing the survey database. When the RFID tag moves within proximity of the RFID reader, the RFID reader determines the identifier of the RFID tag. The identifier is transferred to the host computer which retrieves the participant information in the survey database. Based upon the location of the RFID reader and the participant information, the system may select a survey 50 for the participant. Preferably, interactive voice response (IVR) surveys are used. However, any survey process could be used. Furthermore, while the present invention is described herein as an automatic process, representatives may be used to conduct surveys where appropriate. Using the participant information, the survey system 50 calls the participant's mobile telephone 20. The survey system 50 proceeds to conduct the selected survey with the participant.

The present invention provides targeted consumer surveys at the time when the participant is making a purchase decision. RFID readers are placed at strategic locations in a store in order to gauge whether a participant is likely to be making a purchase decision with respect to certain products. FIG. 2 illustrates possible RFID reader placement. As illustrated in FIG. 2, when a participant wishes to purchase a specific product or type of product, the participant 120 will typically stand in front of a display or shelving 110 having the desired products. A mat type RFID reader 130 can be placed in front of the shelving. The mat type RFID reader can be sized to generally cover the area in front of the relevant products. Since surveys are not conducted for all products, a few mat type RFID readers may be used throughout a store.

Alternatively, other types of RFID readers could be used. For example, upright RFID readers 141, 142 can be placed at either end of an aisle with the relevant products. The RFID readers determine when a participant is present in the aisle by reading the RFID tag upon entering and exiting the aisle. Such RFID readers are not as efficient as a mat type reader. Typically, a single aisle in a store will have several different types of products. The presence of a customer in the aisle, therefore, will not necessarily represent a potential purchaser of the product of interest.

A survey may be conducted in a single store. Preferably, a plurality of stores carrying the same types of products would be used for a survey. The stores will each include RFID readers connected to a single host computer, either through a network or through telephone lines, having the survey database.

FIG. 3 is a flow diagram of operation of the survey system according to an embodiment of the present invention. At step 210, an RFID tag is read by an appropriate RFID reader. At step 220, the system determines whether the participant has been present at the location for more than a minimum period of time. For a mat type RFID reader, the time can be determined by continuously reading the RFID tag. If the RFID tag is can still be read after the minimum time, then the process continues to step 230. For RFID readers at the end of an aisle, the system determines when the participant enters the aisle and whether the participant has left the aisle before the minimum time. If the minimum time is not met, then the operation of the system ends for that participant and reader location. The minimum time is used to judge whether the participant is making a purchase decision. In some instances, particularly with general readers, the presence of the RFID tag by the reader may not signify a purchase decision. The participant may merely be walking down an aisle and not shopping in that aisle.

If the minimum time is met, then the system accesses the survey database to retrieve the information with respect to the participant. The demographic information is analyzed at step 240 to determine whether the participant meets the desired demographic profile. Demographics may be used to restrict the survey to certain types of people. Additionally, for a proper survey, a mix of demographic characteristics is generally desirable. The current survey may already have participants with the demographics of the current consumer. If the demographic criteria are not met, then the system terminates the process with that customer at step 280. If the participant meets the demographic criteria, the system calls the participant's mobile phone at step 250. At step 260, a survey is conducted relative the products which are likely the subject of the participant's interest.

The information gleaned from the surveys conducted with the present invention can be more useful than typical consumer survey techniques. Surveys based upon prior product purchases can gain insight into the reasons that a product was selected over other products. However, they are not very good at estimating the process consumers use during the selection process. The system of the present invention locates purchasers who are in the process of making a purchase decision and considering the possibilities. The survey can be conducted at the precise moments when the options are being considered and the decision is being made. Furthermore, the demographic mix of the survey can be easily controlled. All demographic information is considered before conducting the survey. Also, the system provides a group of willing participants for the survey. All participants have previously agreed to participate in such surveys and have provided information necessary to conduct the survey.

The present invention has been described with respect to use of RFID tags and readers for locating the participant. Other mechanisms may now be available or may be developed for locating participants who are likely making a purchase decision relevant to a survey. For example, facial recognition systems may be used to locate participants. With such a system, cameras are placed at locations of interest, similar to the positioning of RFID readers. A camera would retrieve an image of a customer. The image is compared, using facial recognition technology, to determine the identity of the participant for retrieval of demographic information and conducting the survey.

Alternatively, GPS technology can be used to determine the location of participants. Rather than a RFID tag, each participant may have a GSP device for determining position. The participant's position can be transmitted, for example, using wireless communications, to the survey system. The position can be used to determine location and conduct an appropriate survey.

Furthermore, the system is not limited to use of a mobile phone for conducting the survey. Other devices could be used, including wireless email or text messaging.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A method for conducting a targeted survey of consumers, the method comprising the steps of:
determining that a first consumer is likely making a purchase decision based upon the location of the consumer;
selecting a survey relating to the purchase decision; and
conducting the survey with the first consumer.

2. The method for conducting a targeted survey of consumers according to claim 1 further comprising, before the determining step, the step of collecting information relating to a plurality of consumers including the first consumer.

3. The method for conducting a targeted survey of consumers according to claim 2, wherein the information includes demographic information.

4. The method for conducting a targeted survey of consumers according to claim 2, wherein the selecting step includes selecting a survey based upon collected information relating to the first consumer.

5. The method for conducting a targeted survey of consumers according to claim 1, wherein the determining step includes the steps of:
identifying a first location wherein a consumer is likely to be making a purchase decision; and
determining the presence of the first consumer at the first location for at least a predetermined period of time.

6. The method for conducting a targeted survey of consumers according to claim 5, wherein the identifying step includes positioning at least one RFID reader at the first location; and wherein the step of determining the presence of the first consumer includes the steps of:
associating an RFID tag with the first consumer; and
reading the RFID tag with the at least one RFID reader.

7. The method for conducting a targeted survey of consumers according to claim 1, wherein the step of conducting the survey includes the step of calling the first consumer on a mobile phone.

8. A consumer surveying method comprising the steps of:
collecting information relating to a plurality of survey participants;
providing each of the plurality of survey participants with an identification device from a plurality of identification devices;
determining the presence of one of the plurality of identification devices at a predetermined location; and
conducting a survey of a survey participant provided with the one of the plurality of identification devices.

9. The consumer surveying method according to claim 8, wherein the plurality of identification devices is a plurality of RFID tags; and wherein the determining step includes the steps of:
positioning at least one RFID reader at the predetermined location; and
reading RFID tags with the at least one RFID reader.

10. The consumer surveying method according to claim 8, wherein the information includes demographic information; and wherein the conducting step includes the steps of:
accessing demographic information relating to the survey participant; and
selecting a survey based upon the predetermined location and the demographic information.

11. The consumer surveying method according to claim 8, wherein the conducting step includes the steps of calling a mobile phone of the survey participant.

12. A system for conducting a consumer survey comprising:
a plurality of identification devices, each identification device being associated with one of a plurality of participants;
a reader for determining the location of at least one of the plurality of identification devices;
an automated survey system for conducting a telephonic survey of a first one of the plurality of participants based upon a determined location of an identification device associated with the first one of the plurality of participants.

13. The system for conducting a consumer survey according to claim 12, further comprising:
a database of demographic information relating to the plurality of participants; and
a survey selection system for selecting one of a plurality of telephonic surveys based upon demographic information in the database.

14. The system for conducting a consumer survey according to claim 12, wherein the automated survey system conducts a survey through a mobile phone belonging to the first one of the plurality of participants.

15. The system for conducting a consumer survey according to claim 12,
wherein the plurality of identification devices are RFID tags; and
wherein the reader is an RFID reader.

16. The system for conducting a consumer survey according to claim 15, wherein the reader is positioned at a location at which a consumer is likely to be making a purchase decision.

17. The system for conducting a consumer survey according to claim 16, wherein the reader is positioned near merchandise in a store.

18. The system for conducting a consumer survey according to claim 12, further comprising a plurality of readers for determining a plurality of locations of identification devices.
